(19) United States
(12) Patent Application Publication
(10) Pub. No.: US 2024/0249128 A1
(43) Pub. Date: Jul. 25, 2024

(54) EFFICIENT TENSOR REMATERIALIZATION FOR NEURAL NETWORKS

(71) Applicant: QUALCOMM Incorporated, San Diego, CA (US)

(72) Inventors: Burak BARTAN, San Diego, CA (US); Edward TEAGUE, San Diego, CA (US); Christopher LOTT, San Diego, CA (US)

(21) Appl. No.: 18/353,637

(22) Filed: Jul. 17, 2023

Related U.S. Application Data
(60) Provisional application No. 63/441,150, filed on Jan. 25, 2023.

(51) Int. Cl. G06N 3/063

(52) U.S. Cl. CPC G06N 3/063

(57) ABSTRACT

A processor-implemented method for rematerialization for an artificial neural network (ANN) includes receiving a graph representing the ANN. The graph includes multiple nodes connected by edges and each node represents an operation. Retention intervals for the nodes are determined based on a precedence constraint for the nodes. The retention intervals correspond to a time interval for retaining each node output in a local memory. One of the nodes to recompute is determined based on the retention intervals.

### CROSS-REFERENCE TO RELATED APPLICATION

The present application claims the benefit of U.S. Provisional Patent Application No. 63/441,150, filed on Jan. 25, 2023, and titled “EFFICIENT TENSOR REMATERIALIZATION FOR NEURAL NETWORKS,” the disclosure of which is expressly incorporated by reference in its entirety.

### FIELD OF THE DISCLOSURE

Aspects of the present disclosure generally relate to efficient tensor rematerialization for neural networks.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. CNNs, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use thereof on edge devices such as smartphones. However, edge devices have limited computational resources and generalized models may utilize more complex networks and more computation. As such, the memory footprint and high latency for neural networks make their use challenging, particularly for efficient deployment and inference on resource-limited devices.

One approach to reducing the memory footprint is rematerialization. Rematerialization involves recomputing certain operations rather than retaining the outputs of such operations in memory. However, determining the outputs of operations (which may be represented as nodes in a graph) to be rematerialized is a combinational optimization problem, which may be challenging to solve.

### SUMMARY

The present disclosure is set forth in the independent claims, respectively. Some aspects of the disclosure are described in the dependent claims.

In some aspects of the present disclosure, a processor-implemented method, performed by at least one processor, includes receiving a graph representing an artificial neural network (ANN). The graph includes multiple nodes connected by edges and each node represents an operation. The processor-implemented method further includes determining, by the at least one processor, retention intervals for the nodes based on a precedence constraint for the nodes. The retention intervals correspond to a time interval for retaining each node output in a local memory. The processor-implemented method still further includes determining, by the at least one processor, a node of the multiple nodes to recompute based on the retention intervals.

Some aspects of the present disclosure is directed to an apparatus including means for receiving a graph representing an artificial neural network (ANN). The graph includes multiple nodes connected by edges and each node represents an operation. The apparatus also includes means for determining retention intervals for the nodes based on a precedence constraint for the nodes. The retention intervals correspond to a time interval for retaining each node output in a local memory. The apparatus further includes means for determining a node of the multiple nodes to recompute based on the retention intervals.

In some aspects of the present disclosure, a non-transitory computer-readable medium with program code recorded thereon is disclosed. The program code is executed by a processor and includes program code to receive a graph representing an artificial neural network (ANN). The graph includes multiple nodes connected by edges and each node represents an operation. The program code further includes program code to determine retention intervals for the nodes based on a precedence constraint for the nodes. The retention intervals correspond to a time interval for retaining each node output in a local memory. The program code still further includes program code to determine a node of the multiple nodes to recompute based on the retention intervals.

Some aspects of the present disclosure is directed to an apparatus having a global memory and one or more processors coupled to the global memory. The processor(s) is configured to receive a graph representing an artificial neural network (ANN). The graph includes multiple nodes connected by edges and each node represents an operation. The processor(s) is also configured to determine retention intervals for the multiple nodes based on a precedence constraint for the multiple nodes. The retention intervals correspond to a time interval for retaining each node output in a local memory. The processor(s) is further configured to determine a node of the multiple nodes to recompute based on the retention intervals.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is an example graph illustrating a tradeoff between memory utilization and compute time, in accordance with various aspects of the present disclosure.

FIG. 6A is an example compute graph, in accordance with various aspects of the present disclosure.

FIG. 6B is a diagram illustrating example retention intervals for executing the example compute graph of FIG. 6A, in accordance with various aspects of the present disclosure.

FIG. 7 is a flow diagram illustrating a processor-implemented method for efficient tensor rematerialization for artificial neural networks, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The deployment and training of neural networks on computing devices pose many challenges. The low memory constraints of edge devices are often one of the biggest limiting factors encountered in the deployment of large neural network models. Tensor rematerialization (also referred to as recompute) may address higher memory demands for neural network training and inference.

Many computer architectures for deep neural networks (DNNs) make use of the limited amount of fast, local cache memory (e.g., tightly coupled memory) in conjunction with a much larger amount of external memory (e.g., global memory or system memory), which is significantly slower to access. For example, accelerators for mobile devices today may dedicate several megabytes of local cache for each core for storage of intermediate output sensors before resorting to the main memory of the mobile device. Additionally, training of large DNNs may be primarily conducted on the GPU's local graphics double data rate (GDDR) memory before offloading tensors to a DDR memory on the motherboard of the mobile device. However, there are many DNNs in practice where the amount of memory is insufficient to store all of the intermediate outputs. On-device training of resource limited devices may further exacerbate the deficiency.

One approach for addressing this problem is rematerialization. When input data is used for a compute operation, the data may be read from memory, or alternatively, the data may be discarded and recomputed (rematerialized) when the data is to be used. The extra compute may be advantageous relative to occupying valuable local cache memory with the data until the data is ready to be used. However, deciding which operations (nodes) in DNNs to rematerialize or not in order to improve or optimize latency and memory use may be a hard combinational problem.

Some conventional approaches formulate a mixed integer linear program (MILP) with a Boolean variable for each use of a compute node's output—either read from memory or rematerialized. This formulation has limitations when attempting to scale to large graphs due to the demand for O(n²) Boolean variables (where n is the number of nodes in the computation graph). While linear relaxation followed by rounding is an approximation that is leveraged in such conventional approaches, these rounded solutions may be far from optimal, limiting the applicability of such approaches.

Aspects of the present disclosure are directed to efficient tensor rematerialization for artificial neural networks. Particular aspects of the subject matter described in this disclosure can be implemented to realize one or more of the following potential advantages. In some examples, the described techniques, such as determining retention intervals for the multiple nodes and determining a node of the multiple nodes to recompute based on the retention intervals may reduce peak memory utilization and memory footprint.

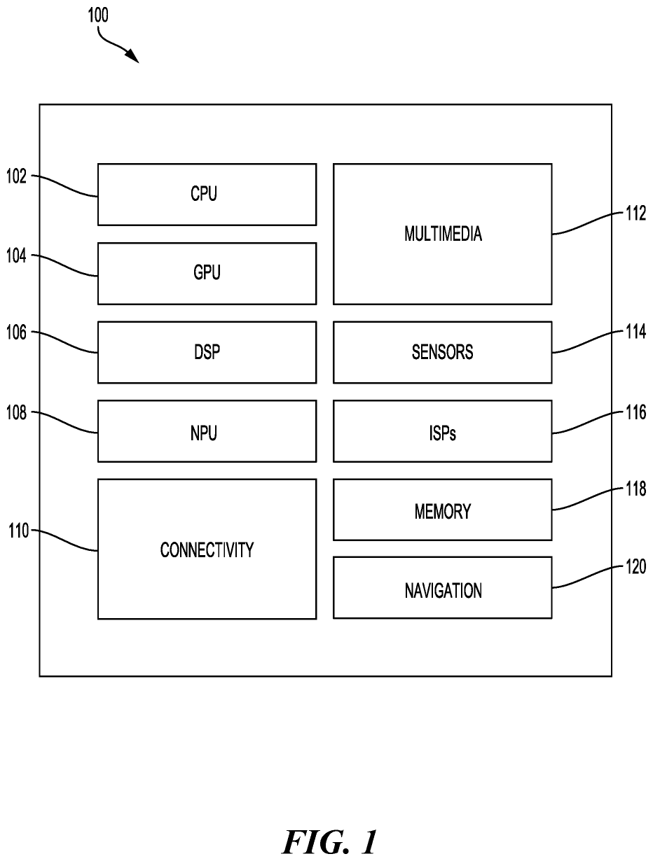

FIG. 1 illustrates an example implementation of a system-on-a-chip (SOC) 100, which may include a central processing unit (CPU) 102 or a multi-core CPU configured for tensor rematerialization for artificial neural networks. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, by at least one processor, a graph representing an artificial neural network (ANN). The graph includes multiple nodes connected by edges and each node represents an operation. The general-purpose processor 102 may also include code to determine, by the at least one processor, retention intervals for the nodes based on a precedence constraint for the nodes. The retention intervals correspond to a time interval for retaining each node output in a local memory. The general-purpose processor 102 may further include code to determine, by the at least one processor, a node of the multiple nodes to recompute based on the retention intervals.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

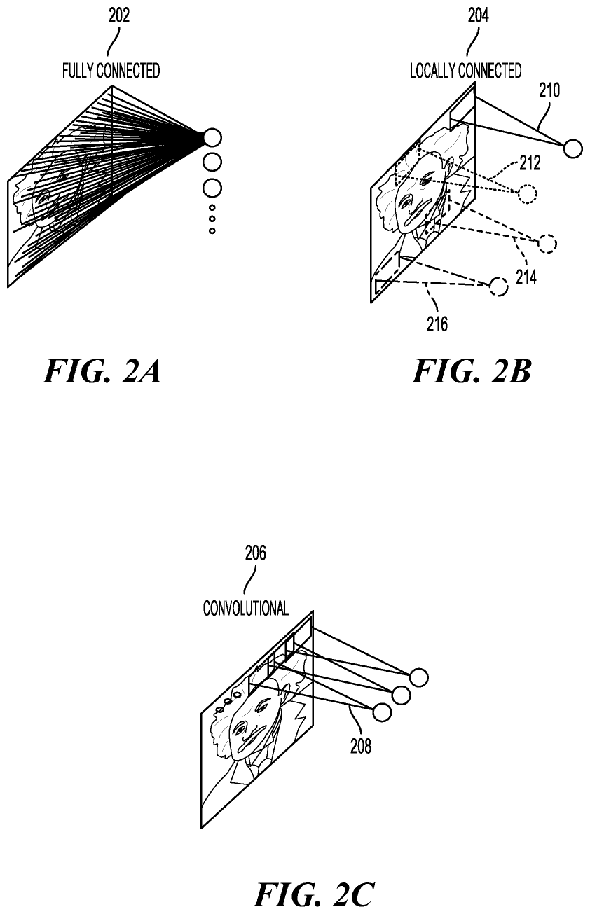

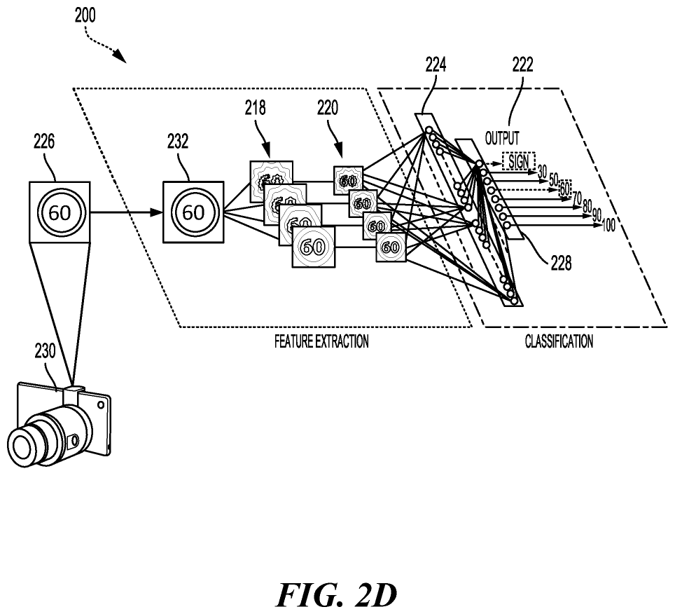

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

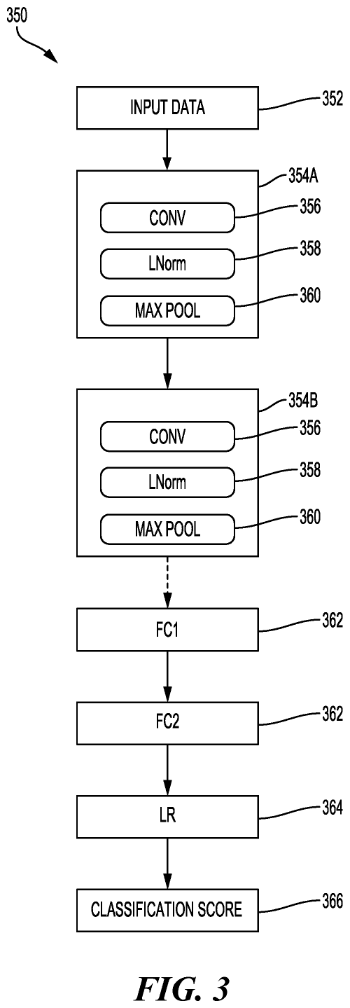

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

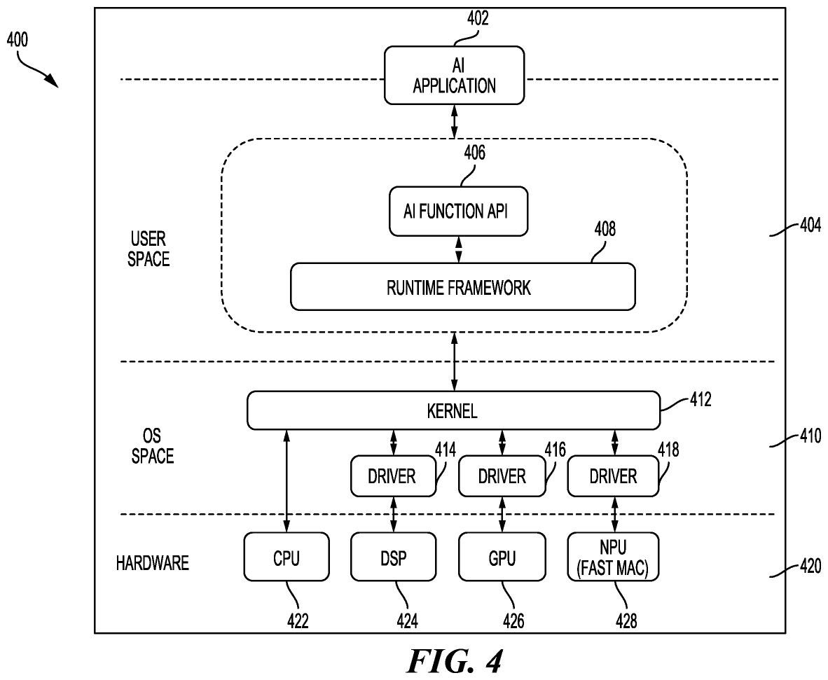

FIG. 4 is a block diagram illustrating an exemplary software architecture 400 that may modularize artificial intelligence (AI) functions. Using the architecture, applications may be designed that may cause various processing blocks of a system-on-a-chip (SOC) 420 (for example a CPU 422, a DSP 424, a GPU 426 and/or an NPU 428) (which may be similar to the SOC 100 of FIG. 1) to support tensor rematerialization for artificial neural networks for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in the user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to efficient tensor rematerialization for artificial neural networks.

Given a directed acyclic graph (DAG), G=(V, E), with |V|=n and |E|=m, nodes v∈V may represent compute operations and directed edges (u, v)∈E represent data dependencies such that the output tensors of all the nodes { [symbol] :( [symbol] , [symbol] )ϵE} (predecessors of v) have to be present in local memory before computing v. Aspects of the present disclosure may determine a rematerialization sequence of nodes (e.g., an ordered list) seq(G) that includes each node at least once. The rematerialization sequence seq(G) may be determined such that the total execution duration may be reduced, and in some aspects, minimized. The rematerialization sequence seq(G) may be subject to a precedence constraint in which the determined sequence seq(G) satisfies the data dependencies of the DAG G. The rematerialization sequence seq(G) may also be subject to a memory constraint that limits the peak memory footprint of the rematerialization sequence seq(G) such that it is less than or equal to the local memory (e.g., a tightly coupled memory) capacity M (e.g., 8 MB).

Accordingly, aspects of the present disclosure provide an optimization model formulation that defines the problem variables as retention intervals, allowing use of only O(n) integer variables. Constrained programming (CP) may be leveraged, allowing complex data dependency and cumulative memory threshold constraints to be easily and efficiently enforced during optimization.

In accordance with some aspects of the present disclosure, output retention intervals may model a duration or time interval for retaining an output of a node in a local memory. For each node, Cᵥ retention intervals may be defined, where each interval represents a rematerialization (also referred to as “recompute”) of that node. The starting times sᵥⁱ of the intervals and the ending times eᵥⁱ of the intervals may be modeled as decision variables of an optimization problem. Precedence constraints and memory constraints may be, in turn, determined based on these decision variables. As such, the determination of which of the nodes to recompute may be solved numerically. Furthermore, the rematerialization sequence seq(G) which may comprise an order for executing the nodes, including the recomputed nodes, may be determined based on the precedence constraint and the memory constraint.

The term rematerialization may be used for the first time that a node is computed as well each subsequent time that the node is computed. In some aspects, the number of times that a node may be rematerialized may be limited to Cᵥ times, hence Cᵥ intervals will be defined for node v. As such, the parameter Cᵥ may be considered a hyperparameter.

Accordingly, the retention intervals for each node v∈V may be defined by its “start” and “end” times as: sᵥⁱ, eᵥⁱ∈ [symbol] , ∀ [symbol] ∈{1, . . . , Cᵥ)}, where the domain [symbol] is a set of integers of size O(n). A memory block of size mᵥ may be allocated at the start and deallocated at the end of the interval.

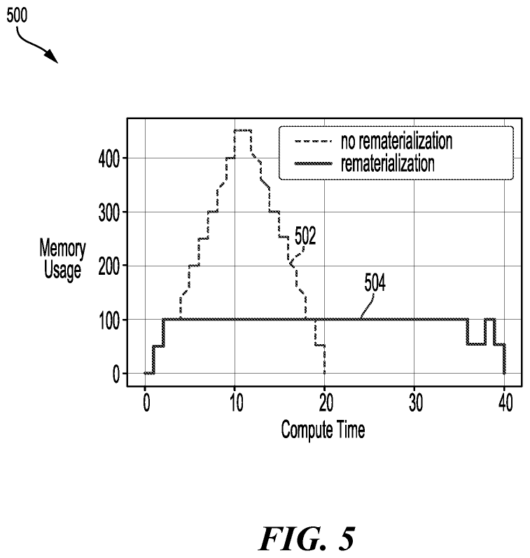

FIG. 5 is an example graph 500 illustrating a tradeoff between memory utilization and compute time, in accordance with certain aspects of the present disclosure. As shown in the example of FIG. 5, when rematerialization is not performed, compute time for computing a sequence of nodes of a compute graph may be lower, but the peak memory usage of tightly coupled memory (e.g., memory 118 of SOC 100 shown in FIG. 1) may increase (as shown in line 502). On the other hand, when rematerialization is performed, the memory usage may be reduced at the expense of a significant increase in compute time (e.g., nearly double) (as shown in line 504).

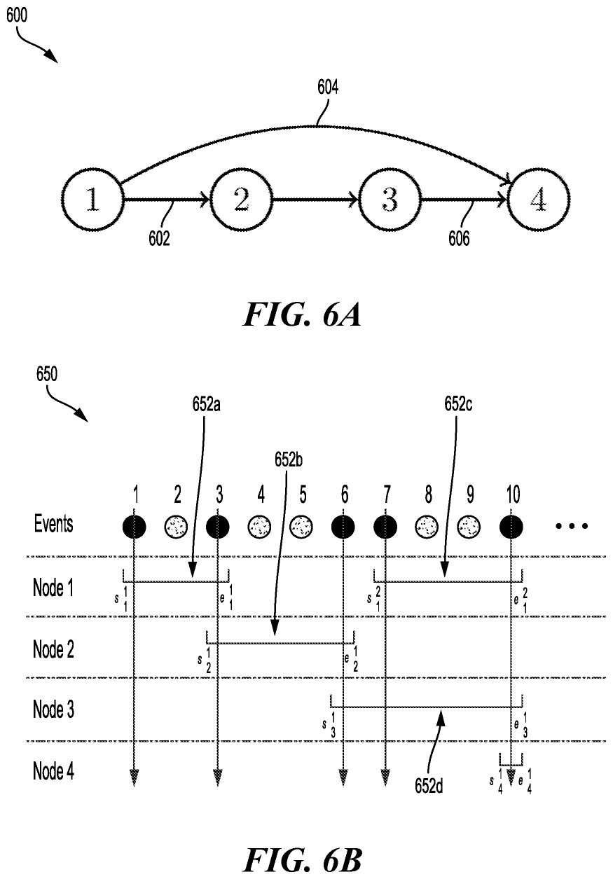

FIG. 6A is a diagram illustrating an example compute graph 600, in accordance with various aspects of the present disclosure. Referring to FIG. 6A, the example compute graph may include four nodes (labeled 1-4). Although four nodes are shown in the example of FIG. 6A, the present disclosure is not so limiting, and any number of nodes may be included.

The nodes may be coupled by edges (shown as arrows between the nodes). Each of the edges and the direction of the arrow may indicate dependencies among the nodes. For instance, edge 602 may indicate that the operation of node 2 depends on the output of node 1. In another example, edge 604 and edge 606 may respectively indicate that the operation of node 4 depends on the output of node 1 and the output of node 3.

FIG. 6B is a diagram 650 illustrating example retention intervals for executing the example compute graph 600 of FIG. 6A, in accordance with various aspects of the present disclosure. A set of potential node execution events are shown for executing nodes 1-4 of the example compute graph 600. In accordance with some aspects of the present disclosure, retention intervals (e.g., 652a-d) for execution of each of the nodes may be determined. Four retention intervals are shown in the example of FIG. 6B; however this is merely for ease of illustration and not limiting. Rather, it should be understood that any number of retention intervals may be determined in accordance with the nodes of the compute graph.

For each retention interval (e.g., 652a-d), a first time slot (shown using a filled event circle) may indicate the computation of node v, while the rest of the retention interval (e.g., 652a-d) may indicate the retention of the output of node v in memory (e.g., memory 118 shown in FIG. 1). The other event circles shown with pattern fill (e.g., event 2) may indicate that no retention interval starts at that particular time (e.g., no computation occurs). However, the determination of the node execution events is a byproduct of the optimization problem and may not be known ahead of time.

As shown in the example of FIG. 6B, node 1 may be computed during event 1. Because the operation of node 2 depends on the output of node 1, the node 1 output may be retained in memory until event 3. At event 3, node 2 may be executed, and the node 2 output may be retained in the memory until event 6.

After event 3, the node 1 output may be discarded. However, because the operation of node 4 also depends on the node 1 output, the node 1 output may be recomputed. A second interval for node 1 may start at event 7, indicating that node 1 is recomputed during event 7.

The event 1 may have a memory usage of m₁. On the other hand, because the operation of node 4 depends on the node 3 output, the node 3 output may also be retained in memory when node 1 is recomputed. Thus, event 7 may have a memory usage of m₁+m₃.

The total duration of the rematerialization sequence may be a weighted sum of the events in which a node is being executed, where the weights may be the actual durations of the nodes (e.g., in seconds or processor cycles). The peak memory footprint may then be the maximum memory usage among all events. Accordingly, if each node outputs a unit-size tensor, the peak memory footprint of the solution in FIG. 6B, may be realized at event 10, where the node 1 output and node 3 output are retained in memory during the execution of node 4.

In addition to the start and end times of the retention intervals (e.g., 652a-d), Boolean variables aᵥⁱ may be defined to model whether the i-th interval of node v is active or inactive. As such, flexibility in the number of times a node v is rematerialized may be provided (e.g., may be other than exactly Cᵥ times). If node u is inactive (e.g., aᵥⁱ=0), the corresponding retention interval may not contribute to the total execution duration in a rematerialization objective as well as the sums in the memory and precedence constraints. The node execution duration wᵥ and node output size mᵥ for each node may be unknown. Using the retention intervals as the foundation, the rematerialization problem may be specified as follows:

$$\begin{matrix}minimize \\ s , e , a\end{matrix} {\sum }_{v , i} {w}_{v} {a}_{v}^{i} \qquad ( 1 )$$

$$subject to {s}_{v}^{i} \leq {e}_{v}^{i} , ∀ v , i \qquad ( 2 )$$

$${e}_{v}^{i} \leq {s}_{v}^{i + 1} , ∀ v , ∀ i < {C}_{v} \qquad ( 3 )$$

$${\sum }_{v , i : {s}_{v}^{i} \leq t \leq {e}_{v}^{i}} {m}_{v} {a}_{v}^{i} \leq M , ∀ t ∈ D \qquad ( 4 )$$

$$\begin{matrix}∀ ( u , v ) ∈ E , ∀ i ∈ \{ i : {a}_{v}^{i} = 1 \} , ∃ j \\ such that \\ {a}_{u}^{j} = 1 , {s}_{u}^{j} + 1 \leq {s}_{v}^{i} \leq {e}_{u}^{j}\end{matrix} \qquad ( 5 )$$

$${s}_{v}^{i} \neq {s}_{u}^{j} , ∀ v , u ∈ \{ v , u : v \neq u \} , ∀ i , j \qquad ( 6 )$$

$${a}_{v}^{i} = 1 , ∀ v \qquad ( 7 )$$

$${s}_{v}^{i} , {e}_{v}^{i} ∈ D , {a}_{v}^{i} ∈ \{ 0 , 1 \} , ∀ v , i . \qquad ( 8 )$$

The objective defined in Equation 1 is the total duration for executing the compute graph (e.g., compute graph 600 of FIG. 6A). Equation 2 is a constraint that enforces the end time of each interval to arrive after its start time. Equation 3 is a constraint that ensure that retention intervals of the same node do not overlap. Equation 4 specifies memory constraints (may be referred to as a memory budget), where the parameter t represents time. Equation 5 specifies precedence constraints that enforce an overlapping and active interval for all predecessors of node v at all start times sᵥⁱ of v. As such, the memory constraint and precedence constraint may be nonlinear constraints. Equation 6 is a constraint specifying the starting times of the intervals are all different (e.g., compute events do not overlap). Equation 7 provides a constraint specifying the first retention interval for every node is active. Equation 8 provides a constraint specifying for each active interval for a node v there is a start time sᵥⁱ and an end time eᵥⁱ.

The domain of the variables sᵢ^{v}, eᵥⁱ may be defined as follows:

$$D = \{ 1 , 2 , … , {\sum }_{v} {c}_{v} \} , \qquad ( 9 )$$

where ΣᵥCᵥ is equal to the number of intervals, which may be upper bounded by |D|≤n maxᵥCᵥ.

The memory constraints specified in Equation 4 may limit the resource usage to the local memory budget M (e.g., capacity) at time t. In some aspects, the memory constraint may be non-linear in the variables sᵥⁱ, eᵥⁱ. This type of inequality can be modeled using the constrained programming (CP) constraint cumulative.

Referring to FIG. 6B, the memory constraint (e.g., Equation 4) may limit the peak memory footprint at each execution event to be less than the local memory budget M. That is, the sum of the node output sizes my for each retention interval at such execution events are less than or equal to M.

As described, the precedence constraints of Equation 5 provide that prior to the execution of each compute task (e.g., execution of a node), the outputs of all predecessors' nodes are available in memory. The data dependencies (as indicated by the edges (e.g., 602) shown in FIG. 6A) may be modeled as reservoir constraints from constraint programming. For instance, each predecessor node (e.g., node 1 is a predecessor of node 2 and node 4) may be considered a resource whose level has to be maintained such that the resource does not go below zero while its node successor is being executed.

The resource level change events ƒ(·) for each edge (u, v)∈E and {1, . . . , Cᵥ} may be defined as follows:

$$\begin{matrix}f ( {s}_{v}^{i} ) = - 1 \\ f ( {s}_{v}^{i} + 1 ) = 1 \\ f ( {s}_{u}^{1} ) = 1 , f ( {s}_{u}^{2} ) = 1 , … , f ( {s}_{u}^{{c}_{u}} ) = 1 \\ f ( {e}_{u}^{1} ) = - 1 , f ( {e}_{u}^{2} ) = - 1 , … , f ( {e}_{u}^{{c}_{u}} ) = - 1.\end{matrix} \qquad ( 10 )$$

The level change function ƒ(·) may return zero at every other point in time, except for those in Equation 10.

Accordingly, aspects of the present disclosure offer the flexibility of allowing solutions that are not limited to a predetermined topological ordering. However, in some aspects, an input topological ordering may be enforced to reduce the size of the search space, and in turn, reduce the solution time for determining the retention intervals.

For example, considering a new domain for the integer variables sᵥⁱ, eᵥⁱ:

$$D = \{ 1 , 2 , … , \frac{n ( n + 1 )}{2} \} , \qquad ( 11 )$$

where the domain size in this example is O(n²) rather than O(n). The determination of retention intervals may be conducted in stages. The j-th stage may include j events. Given a topological ordering of the nodes, the first stage may enforce the computation of the first node in the order. In subsequent stages, the j-th node in the input topological order may be enforced to be computed in the last event of stage j, while the preceding events in stage j permits nodes 1, . . . , (j−1) to be computed. That is, a constraint that node j may be computed only in event j of a stage may be applied. Because such a constraint may restrict the starting times of each interval to specific events, the constraint in Equation 6 may be eliminated.

As such, the start time for the first retention interval for each node may no longer be a variable but a fixed value. More precisely, for node v, the value of sᵥ¹ may be equal to j(j+1)/2, where j is the index of node v in the input topological ordering.

In some aspects, the retention intervals may be determined in two phases. In phase 1, a variant of the optimization problem specified in Equations 1-8 may be solved to find a memory-feasible solution. Then, the solution of phase 1 may be used as initialization for phase 2, which is the optimization problem specified in Equations 1-8. The problem in phase 1 has an objective:

$$\begin{matrix}minimize \\ s , e , a , {M}_{var}\end{matrix} max ( {M}_{var} , M ) , \qquad ( 12 )$$

where Mᵥₐᵣ∈ [symbol] is the peak memory footprint. The memory constraint in Equation 4 may be modified as follows for phase 1:

$${\sum }_{v , i : {s}_{v}^{i} \leq t \leq {e}_{v}^{i}} {m}_{v} {a}_{v}^{i} \leq {M}_{var} , ∀ t ∈ D . \qquad ( 13 )$$

One goal of phase 1 may be to determine an intermediate solution in which the peak memory footprint is below the local memory target M. This goal may be accomplished by considering the maximum of the peak memory variable Mᵥₐᵣ and memory budget M as the objective. This objective may be linearized by introducing an auxiliary variable τ∈ [symbol] and then considering: minimize τ subject to τ≥Mᵥₐᵣ and τ≥M. The other constraints of the optimization problem as described in Equations 1-8 may be unchanged.

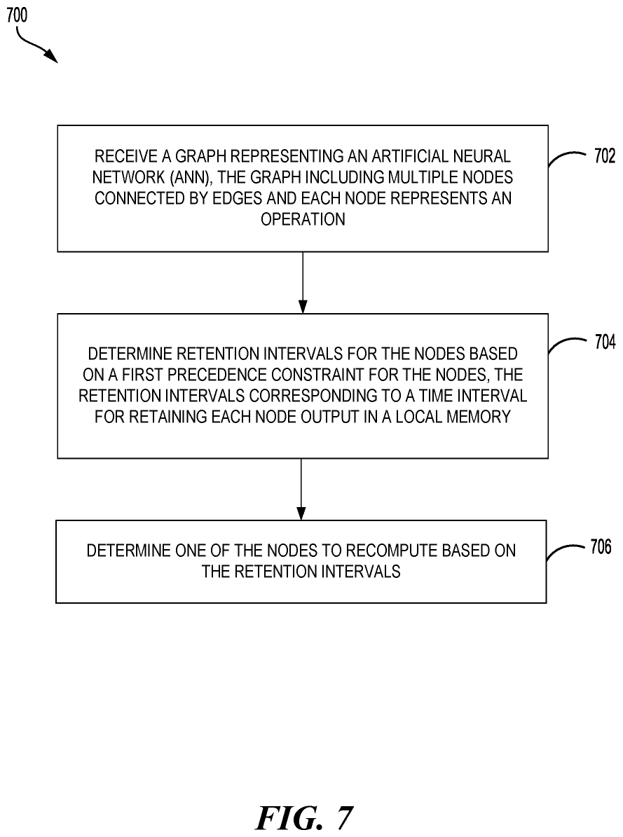

FIG. 7 is a flow diagram illustrating a processor-implemented method 700 for tensor rematerialization in an artificial neural network (ANN), in accordance with various aspects of the present disclosure. The processor-implemented method 700 may be performed by one or more processors such as the CPU (e.g., 102, 422), GPU (e.g., 104, 426), and/or other processing units (e.g., DSP 424 or NPU 428), for example. In some aspects, the processor-implemented method 700 may be implemented in a compiler.

As shown in FIG. 7, at block 702, a processor receives a graph representing the ANN. In some aspects, the graph may comprise a DAG. The graph includes multiple nodes connected by edges. Each node represents an operation. As described, nodes v∈V may represent compute operations, and directed edges (u, v)∈E may represent data dependencies such that the output tensors of all the nodes { [symbol] :( [symbol] , [symbol] )ϵE} (predecessors of v) have to be present in local memory before computing v.

At block 704, the processor determines retention intervals for the nodes based on a precedence constraint for the nodes. The retention intervals correspond to a time interval for retaining each node output in a local memory. As described, output retention intervals may model a duration or time interval for retaining an output of a node in a local memory. For each node, Cᵥ retention intervals may be defined, where each retention interval may represent a rematerialization (also referred to as “recompute”) of that node.

At block 706, the processor determines one of the nodes to recompute based on the retention intervals. For instance, as described, the starting times sᵥⁱ of the intervals and the ending times eᵥⁱ of the intervals may be modeled as decision variables of an optimization problem. Precedence constraints and memory constraints may be, in turn, determined based on these decision variables. As such, the determination of which of the nodes to recompute may be solved numerically.

Implementation examples are provided in the following numbered clauses.
1. A processor-implemented method, performed by at least one processor, the method comprising:
   receiving, by the at least one processor, a graph representing an artificial neural network (ANN), the graph including multiple nodes connected by edges and each node represents an operation;
   determining, by the at least one processor, retention intervals for the multiple nodes based on a precedence constraint for the multiple nodes, the retention intervals corresponding to a time interval for retaining each node output in a local memory; and
   determining, by the at least one processor, a node of the multiple nodes to recompute based on the retention intervals.
2. The processor-implemented method of clause 1, further comprising determining, by the at least one processor, an order for execution of the multiple nodes based on the precedence constraint and a memory constraint.
3. The processor-implemented method of clause 1 or 2, further comprising determining, by the at least one processor, the precedence constraint for each of the multiple nodes based on the retention intervals.
4. The processor-implemented method of any of clauses 1-3, further comprising determining, by the at least one processor, the memory constraint based on a physical memory capacity of the local memory and the retention intervals.
5. The processor-implemented method of any of clauses 1-4, in which the retention intervals are determined based on a recompute constraint, the recompute constraint defining a number of times that the node is permitted to be recomputed.
6. The processor-implemented method of any of clauses 1-5, in which the precedence constraint is determined based on the edges connecting the multiple nodes.
7. The processor-implemented method of any of clauses 1-6, in which the local memory comprises a tightly-coupled memory.
8. An apparatus, comprising:
   a global memory; and
   at least one processor coupled to the global memory, the at least one processor configured to:
      receive a graph representing an artificial neural network (ANN), the graph including multiple nodes connected by edges and each node represents an operation;
      determine retention intervals for the multiple nodes based on a precedence constraint for the multiple nodes, the retention intervals corresponding to a time interval for retaining each node output in a local memory; and
      determine a node of the multiple nodes to recompute based on the retention intervals.
9. The apparatus of clause 8, in which the at least one processor is further configured to determine an order for execution of the multiple nodes based on the precedence constraint and a memory constraint.
10. The apparatus of clause 8 or 9, in which the at least one processor is further configured to determine the second precedence constraint for each of the multiple nodes based on the retention intervals.
11. The apparatus of any of clauses 8-10, in which the at least one processor is further configured to determine the memory constraint based on a physical memory capacity of the local memory and the retention intervals.
12. The apparatus of any of clauses 8-11, in which the at least one processor is further configured to determine the retention intervals based on a recompute constraint, the recompute constraint defining a number of times that the node is permitted to be recomputed.
13. The apparatus of any of clauses 8-12, in which the at least one processor is further configured to determine the precedence constraint based on the edges connecting the multiple nodes.
14. The apparatus of any of clauses 8-13, in which the local memory comprises a tightly-coupled memory.
15. A non-transitory computer-readable medium having program code recorded thereon, the program code executed by a processor and comprising:
   program code to receive a graph representing an artificial neural network (ANN), the graph including multiple nodes connected by edges and each node represents an operation;
   program code to determine retention intervals for the multiple nodes based on a precedence constraint for the multiple nodes, the retention intervals corresponding to a time interval for retaining each node output in a local memory; and
   program code to determine a node of the multiple nodes to recompute based on the retention intervals.
16. The non-transitory computer-readable medium of clause 15, in which the program code further comprises program code to determine an order for execution of the multiple nodes based on the precedence constraint and a memory constraint.
17. The non-transitory computer-readable medium of clause 15 or 16, in which the program code further comprises program code to determine the second precedence constraint for each of the multiple nodes based on the retention intervals.
18. The non-transitory computer-readable medium of any of clauses 15-17, in which the program code further comprises program code to determine the memory constraint based on a physical memory capacity of the local memory and the retention intervals.
19. The non-transitory computer-readable medium of any of clauses 15-18, in which the program code further comprises program code to determine the retention intervals based on a recompute constraint, the recompute constraint defining a number of times that the node is permitted to be recomputed.
20. The non-transitory computer-readable medium of any of clauses 15-19, in which the program code further comprises program code to determine the precedence constraint based on the edges connecting the multiple nodes.
21. The non-transitory computer-readable medium of any of clauses 15-20, in which the local memory comprises a tightly-coupled memory.
22. An apparatus, comprising:
   means for receiving a graph representing an artificial neural network (ANN), the graph including multiple nodes connected by edges and each node represents an operation;
   means for determining retention intervals for the multiple nodes based on a precedence constraint for the multiple nodes, the retention intervals corresponding to a time interval for retaining each node output in a local memory; and
   means for determining a node of the multiple nodes to recompute based on the retention intervals.
23. The apparatus of clause 22, further comprising means for determining an order for execution of the multiple nodes based on the precedence constraint and a memory constraint.
24. The apparatus of clause 22 or 23, further comprising means for determining the second precedence constraint for each of the multiple nodes based on the retention intervals.
25. The apparatus of any of clauses 22-24, further comprising means for determining the memory constraint based on a physical memory capacity of the local memory and the retention intervals.
26. The apparatus of any of clauses 22-25, further comprising means for determining the retention intervals based on a recompute constraint, the recompute constraint defining a number of times that the node is permitted to be recomputed.
27. The apparatus of any of clauses 22-26, further comprising means for determining the precedence constraint based on the edges connecting the multiple nodes.
28. The apparatus of any of clauses 22-28, in which the local memory comprises a tightly-coupled memory.

In one aspect, the receiving means, the means for determining retention intervals, and/or the means for determining a node of the multiple nodes to recompute may be the GPU 104, program memory associated with the GPU 104, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, performed by at least one processor, the method comprising:
receiving, by the at least one processor, a graph representing an artificial neural network (ANN), the graph including multiple nodes connected by edges and each node represents an operation;
determining, by the at least one processor, retention intervals for the multiple nodes based on a precedence constraint for the multiple nodes, the retention intervals corresponding to a time interval for retaining each node output in a local memory; and
determining, by the at least one processor, a node of the multiple nodes to recompute based on the retention intervals.

2. The processor-implemented method of claim 1, further comprising determining, by the at least one processor, an order for execution of the multiple nodes based on the precedence constraint and a memory constraint.

3. The processor-implemented method of claim 2, further comprising determining, by the at least one processor, the precedence constraint for each of the multiple nodes based on the retention intervals.

4. The processor-implemented method of claim 2, further comprising determining, by the at least one processor, the memory constraint based on a physical memory capacity of the local memory and the retention intervals.

5. The processor-implemented method of claim 1, in which the retention intervals are determined based on a recompute constraint, the recompute constraint defining a number of times that the node is permitted to be recomputed.

6. The processor-implemented method of claim 1, in which the precedence constraint is determined based on the edges connecting the multiple nodes.

7. The processor-implemented method of claim 1, in which the local memory comprises a tightly-coupled memory.

8. An apparatus, comprising:
a global memory; and
at least one processor coupled to the global memory, the at least one processor configured to:
receive a graph representing an artificial neural network (ANN), the graph including multiple nodes connected by edges and each node represents an operation;
determine retention intervals for the multiple nodes based on a precedence constraint for the multiple nodes, the retention intervals corresponding to a time interval for retaining each node output in a local memory; and
determine a node of the multiple nodes to recompute based on the retention intervals.

9. The apparatus of claim 8, in which the at least one processor is further configured to determine an order for execution of the multiple nodes based on the precedence constraint and a memory constraint.

10. The apparatus of claim 9, in which the at least one processor is further configured to determine the second precedence constraint for each of the multiple nodes based on the retention intervals.

11. The apparatus of claim 9, in which the at least one processor is further configured to determine the memory constraint based on a physical memory capacity of the local memory and the retention intervals.

12. The apparatus of claim 8, in which the at least one processor is further configured to determine the retention intervals based on a recompute constraint, the recompute constraint defining a number of times that the node is permitted to be recomputed.

13. The apparatus of claim 8, in which the at least one processor is further configured to determine the precedence constraint based on the edges connecting the multiple nodes.

14. The apparatus of claim 8, in which the local memory comprises a tightly-coupled memory.

15. A non-transitory computer-readable medium having program code recorded thereon, the program code executed by a processor and comprising:
program code to receive a graph representing an artificial neural network (ANN), the graph including multiple nodes connected by edges and each node represents an operation;
program code to determine retention intervals for the multiple nodes based on a precedence constraint for the multiple nodes, the retention intervals corresponding to a time interval for retaining each node output in a local memory; and
program code to determine a node of the multiple nodes to recompute based on the retention intervals.

16. The non-transitory computer-readable medium of claim 15, in which the program code further comprises program code to determine an order for execution of the multiple nodes based on the precedence constraint and a memory constraint.

17. The non-transitory computer-readable medium of claim 16, in which the program code further comprises program code to determine the second precedence constraint for each of the multiple nodes based on the retention intervals.

18. The non-transitory computer-readable medium of claim 16, in which the program code further comprises program code to determine the memory constraint based on a physical memory capacity of the local memory and the retention intervals.

19. The non-transitory computer-readable medium of claim 15, in which the program code further comprises program code to determine the retention intervals based on a recompute constraint, the recompute constraint defining a number of times that the node is permitted to be recomputed.

20. The non-transitory computer-readable medium of claim 15, in which the program code further comprises program code to determine the precedence constraint based on the edges connecting the multiple nodes.

21. The non-transitory computer-readable medium of claim 15, in which the local memory comprises a tightly-coupled memory.

22. An apparatus, comprising:
means for receiving a graph representing an artificial neural network (ANN), the graph including multiple nodes connected by edges and each node represents an operation;
means for determining retention intervals for the multiple nodes based on a precedence constraint for the multiple nodes, the retention intervals corresponding to a time interval for retaining each node output in a local memory; and
means for determining a node of the multiple nodes to recompute based on the retention intervals.

23. The apparatus of claim 22, further comprising means for determining an order for execution of the multiple nodes based on the precedence constraint and a memory constraint.

24. The apparatus of claim 23, further comprising means for determining the second precedence constraint for each of the multiple nodes based on the retention intervals.

25. The apparatus of claim 23, further comprising means for determining the memory constraint based on a physical memory capacity of the local memory and the retention intervals.

26. The apparatus of claim 22, further comprising means for determining the retention intervals based on a recompute constraint, the recompute constraint defining a number of times that the node is permitted to be recomputed.

27. The apparatus of claim 22, further comprising means for determining the precedence constraint based on the edges connecting the multiple nodes.

28. The apparatus of claim 22, in which the local memory comprises a tightly-coupled memory.
